(19) United States
(12) Patent Application Publication
(10) Pub. No.: US 2015/0058518 A1
(43) Pub. Date: Feb. 26, 2015

(54) MODULAR SERVER SYSTEM, I/O MODULE AND SWITCHING METHOD

(71) Applicant: Fujitsu Technology Solutions Intellectual Property GmbH, München (DE)

(72) Inventors: Michael Kleineberg, Lichtenau (DE); Bernhard Schräder, Delbruck (DE); Van Son Nguyen, Warendorf (DE)

(21) Appl. No.: 14/385,302

(22) PCT Filed: Jan. 31, 2013
(86) PCT No.: PCT/EP2013/051947

§ 371 Date: Sep. 15, 2014

(30) Foreign Application Priority Data
Mar. 15, 2012 (DE) 10 2012 102 198.8

(51) Int. Cl. G06F 13/40; H04L 29/08

(52) U.S. Cl. CPC G06F 13/4022; H04L 67/141
USPC 710/316

(57) ABSTRACT

A modular server system includes a plurality of server groups, wherein each server group is adapted to receive a plurality of server modules, and a plurality of I/O groups, wherein each I/O group is adapted to receive a plurality of I/O components and includes a switching arrangement with at least one switch element, wherein each of the plurality of I/O groups is allocated to exactly one of the plurality of server groups, the switch arrangement of each I/O group is directly coupled by a data link to each of the plurality of I/O components of the I/O group, the switch arrangement of each I/O group is directly coupled by a data link to each of the plurality of server modules of the server group allocated to the I/O group, and the switch arrangement of each I/O group is coupled by a data link to at least one other switch arrangement of another I/O group.

### TECHNICAL FIELD

This disclosure relates to a modular server system comprising a plurality of server modules and a plurality of I/O components, as well as an I/O module and a switching method for such a modular server system.

### BACKGROUND

Modular server systems are known. For example, what are called “blade server” systems are known, in which a plurality of blade server modules, each of which comprises at least one processor and associated main memory, access a shared infrastructure, in particular power supplies, network switches and/or mass storage components. The necessary connections between the blade server modules and the shared I/O components are here generally established via what is called a “midplane,” a passive shared printed circuit board of the blade server system.

Other more or less modular server systems are also known. For example, server modules in the form of rack servers are known, which are inserted into a shared rack housing and access shared network switches via cable connections.

If several server modules are to be connected to a plurality of I/O components there are different options for coupling them by a data link.

FIG. 9A shows a first option to connect a plurality of I/O components to a plurality of server modules. In the architecture illustrated in FIG. 9A, each server module la to lc is directly allocated to exactly one I/O component 2a to 2c. The allocation between the server modules 1a to 1c and the corresponding I/O components 2a to 2c is effected via electrical connections 3a to 3c of a server system. Due to the direct allocation of the I/O components 2a to 2c to the server modules 1a to 1c, connections 3a to 3c arranged between them can be configured relatively simply. In particular, they can be conductor tracks on a backplane, or other passive electrical connections.

The architecture illustrated in FIG. 9A has the disadvantage that on failure of any I/O component 2a to 2c or connection 3a to 3c, the associated server module 1a to 1c is no longer able to carry out the tasks assigned to it and is therefore no longer available. Moreover, the architecture illustrated in FIG. 9A is relatively inefficient since I/O components 2a to 2c, for example, network cards, have to be provided separately for each server module 1a to 1c, even though each of the server modules 1a to 1c requires only a small bandwidth that could be provided via a single network card jointly for all server modules 1a to 1c.

FIG. 9B shows an architecture that is more versatile compared to FIG. 9A. In the example illustrated in FIG. 9B, three server modules 1a to 1c share two I/O components 2a and 2b. The connections between the server modules 1a to 1c and the I/O components 2a and 2b are established via a switch element 4. The switch element 4 thus connects first connections 3a to 3c between the server modules 1a to 1c and the switch element 4 selectively to second connections 8a and 8b between the switch element 4 and the I/O components 2a and 2b respectively. In this manner, for example, controlled by address information in the exchanged data, an optional connection between any server module 1a to lc and any I/O component 2a or 2b can be established.

The described architecture has the advantage that I/O components 2a and 2b can be shared by the server modules 1a to 1c, which increases both the utilized capacity of the individual I/O components 2a and 2b and also the availability thereof. For example, a single network card can be shared by all three server modules 1a to 1c. If the I/O components 2a and 2b are comparable components, for example, two network cards of the same type, in the event of one of the two I/O components 2a or 2b failing all server modules 1a to 1c can still successfully establish network connections.

A disadvantage of the architecture illustrated in FIG. 9B is that the connection between the server modules 1a to 1c on the one hand and the I/O components 2a and 2b on the other hand, also known as the connection fabric, is relatively complicated. First, to establish the connections 3 an active component is needed, specifically the switch element 4, which increases both the manufacturing costs and also the complexity of the server system. If, as illustrated in FIG. 9B, a single switch element 4 is used to establish all connections, there is the additional problem of what is called a “single point of failure”, failure of which causes all server modules 1a to 1c to stop working. Moreover, such a switch element 4 could be arranged only in a central component of the modular server system, for example, a backplane or midplane, which would considerably increase their cost.

A further serious problem of the architecture according to FIG. 9B, in particular when using multicore connections 3a to 3e and 8a and 8b, as are used in especially high-performance bus systems like that known as the PCI Express standard, is that the number of lines to be connected rises very steeply with the number of server modules and I/O components used. In a server system with m server modules and n I/O components, the 3×2 switch element 4 illustrated in FIG. 9B becomes an m×n switch element, which is very complicated to produce. As the number of switch connections to server modules 1 and I/O components 2 increases, the implementation of the switch element 4 becomes increasingly difficult. Furthermore, in particular in the bus systems mentioned, it becomes difficult to arrange all necessary lines on a shared printed circuit board such as in particular a midplane. For that reason, such architectures are only practical in relatively small server systems with few components or for electrical connections with one or just a few lines.

It could therefore be helpful to provide an alternative architecture for modular server systems and methods for the operation thereof, which are in particular for high-performance cluster applications and/or high-availability systems.

### SUMMARY

We provide a modular server system including a plurality of server groups, wherein each server group is adapted to receive a plurality of server modules, and a plurality of I/O groups, wherein each I/O group is adapted to receive a plurality of I/O components and comprises a switching arrangement with at least one switch element, wherein each of the plurality of I/O groups is allocated to exactly one of the plurality of server groups, the switch arrangement of each I/O group is directly coupled by a data link to each of the plurality of I/O components of the I/O group, the switch arrangement of each I/O group is directly coupled by a data link to each of the plurality of server modules of the server group allocated to the I/O group, and the switch arrangement of each I/O group is coupled by a data link to at least one other switch arrangement of another I/O group.

We also provide a modular server system including a plurality of server groups, each server group being adapted to receive a plurality of server modules and comprising a switch arrangement with at least one switch element, and a plurality of I/O groups, wherein each I/O group is adapted to receive a plurality of I/O components, wherein each of the plurality of server groups is allocated exactly one of the plurality of I/O groups, the switch arrangement of each server group is directly coupled by a data link to each of the plurality of server modules of the server group, the switch arrangement of each server group is directly coupled by a data link to each of the plurality of I/O components of the I/O group allocated to the server group, and the switch arrangement of each server group is directly coupled by a data link to at least one other switch arrangement of another server group.

We further provide an I/O module for use in a modular server system, including at least one module printed circuit board, at least one first terminal arranged on the module printed circuit board for a first I/O component, at least one second terminal arranged on the module printed circuit board for a second I/O component, at least one plug connector arranged on the module printed circuit board that couples the I/O module to a shared printed circuit board of the modular server system by a data link, and at least one switch element arranged on the module printed circuit board that selectively establishes data connections between a predetermined group of server modules of the modular server system, said predetermined group being allocated to the I/O module, and the first and/or second I/O component, and establishes data connections between the predetermined group of server modules of the modular server system and a switch element of a similar I/O module.

We still further provide a switching method for a modular server system including directly establishing first data connections between a first component of a first type of a first group of similar components, and a second component of a second type of a second group of similar components via a first switch element of the second group; and indirectly establishing second data connections between the first component of the first group and a third component of the second type via the first switch element and a second switch element of the third group.

### BRIEF DESCRIPTION OF THE DRAWINGS

FIG. 1 shows a modular server system according to a first example.

FIG. 2 shows subgroups of a server system according to a second example.

FIG. 3 shows the modular server system according to the second example.

FIG. 4A shows a connection diagram for a subgroup of a modular server system.

FIG. 4B shows a diagram of the connections between different subgroups of a modular server system.

FIG. 5 shows a modular server system according to the third example.

FIG. 6 shows a modular server system according to the fourth example.

FIG. 7 shows a top view onto a housing of a modular server system.

FIG. 8A show a perspective view of a first I/O module.

FIG. 8B shows a perspective view of second I/O module.

FIG. 9A shows a first option for coupling a plurality of components of a known server system.

FIG. 9B shows a second option for coupling a plurality of components of a known server system.

### LIST OF REFERENCE SIGNS

1 Server module
2 I/O component
3 First connection
4 Switch element
5 Modular server system
6 Server group
7 I/O group
8 Second connection
9 Third connection
10 Connection fabric
11 Subgroup
12 Retimer device
13 Front housing segment
14 Midplane
15 Rear housing segment
16 I/O module
17 Module printed circuit board
18 Plug connector
19 PCI Express expansion card

### DETAILED DESCRIPTION

A first aspect of this disclosure is directed to modular server architectures, which allow a plurality of server modules to be coupled to a plurality of I/O components.

A modular server system may comprise a plurality of server groups, each server group being adapted to receive a plurality of server modules. The server system further comprises a plurality of I/O groups, each I/O group being adapted to receive a plurality of I/O components and having a switch arrangement with at least one switch element. Here, each of the plurality of I/O groups is allocated to exactly one of the plurality of server groups. The switch arrangement of each I/O group is directly coupled by a data link to each of the plurality of I/O components of the I/O group and to each of the plurality of server modules of the server group allocated to the I/O group. Moreover, the switch arrangement of each I/O group is coupled by a data link to at least one other switch arrangement of another I/O group.

By separating server modules and I/O components into server groups and I/O groups and by directly allocating I/O groups to exactly one server group, a modular, distributed switch architecture for a modular server system can be implemented. In this case, I/O components of an I/O group connect via a switch arrangement having at least one switch element of the I/O group over a relatively short path to associated server modules of an associated server group, so that a comparatively small number of server modules is able to access a comparatively small number of I/O components with high bandwidth and low latency. Other connections, that is to I/O components of I/O groups allocated to another server group, are here effected via further connections between switch arrangements or rather the switch elements contained therein.

Alternatively, a modular server system may comprise a plurality of server groups, each server group being adapted to receive a plurality of server modules and having a switch arrangement with at least one switch element. The server system further comprises a plurality of I/O groups, each I/O group being adapted to receive a plurality of I/O components. Here, each of the plurality of server groups is allocated to exactly one of the plurality of I/O groups. The switch arrangement of each server group is directly coupled by a data link to each of the plurality of server modules of the server group and to each of the plurality of I/O modules of the I/O group allocated to the server group. Moreover, the switch arrangement of each server group is coupled by a data link to at least one other switch arrangement of another server group.

The modular server system according to the alternative example has substantially the same properties as the first embodiment, the logic allocation between server groups on the one hand a I/O groups on the other hand being reversed.

An advantage of these distributed architectures is that the number of lines and hence, the cost of what is known as the “connection fabric,” does not increase exponentially with the size of the system, but only with the size of the server groups and/or I/O groups used. In this way the complexity and cost of the modular server system can be reduced, the result being that a higher degree of performance, availability and redundancy can be ensured.

Preferably, the connections between the individual components can be established via a shared printed circuit board, in particular a backplane or midplane of the modular server system. Preferably, only passive components, in particular electrical connections in the form of conductor tracks, are applied to the shared printed circuit board to couple the individual components by a data link.

The described server system is suitable in particular to couple point-to-point connections to a plurality of data lines by a data link such as connections according to the PCI Express standard.

Preferably, the I/O components are components that can be shared by a plurality of server modules, for example, network components with a plurality of virtual and/or physical functional units, or mass storage components such as those commonly known as solid-state disks (SSD) and host bus adapters (HBA).

A second aspect of this disclosure is directed to an I/O module for use in a modular server system. The I/O module comprises at least one module printed circuit board, at least one first terminal arranged on the module printed circuit board for a first I/O component, at least one second terminal arranged on the module printed circuit board for a second I/O component and at least one plug connector arranged on the module printed circuit board for coupling the I/O module to a shared printed circuit board of the modular server system by a data link. On the module printed circuit board there is arranged at least one switch element that selectively establishes connections between a predetermined group of server modules of the modular server system, the predetermined group being allocated to the I/O module, and the first and/or second I/O component, and establishes connections between the predetermined group of server modules of the modular server system and a switch element of a similar I/O module.

Such an I/O module with one or more integrated switch elements allows modular server systems with a shared, preferably passive printed circuit board to be set up. In this context, the connections between the first and the second I/O component and a server group allocated to the I/O module are established directly via an integrated switch element. Moreover, indirect connections with other I/O modules can be established via a switch element of the I/O module and a switch element of a similar adjacent I/O module.

A third aspect of this disclosure is directed to a switching method for a modular server system, in which first data connections between a first component of a first type of a first group of similar components, in particular between a server module of a plurality of server modules of a first server group, and a second component of a second type of a second group of similar components, in particular an I/O component of a plurality of I/O components of a first I/O group, are established directly via a first switch element of the second group. In the method, second data connections between the first component of the first group and a third component of the second type, in particular an I/O component of a plurality of I/O components of a second I/O group, are established indirectly via the first switch element and a second switch element of the third group.

Such a distributed and optionally cascadable switching method enables a multiplicity of server modules to be connected to a multiplicity of I/O components in a demand-oriented and simple manner.

Further advantageous configurations are disclosed in the appended claims and in the following detailed description of examples.

Our systems, modules and methods are explained in detail hereinafter by examples and with reference to the figures. In the figures, the same reference signs have been used for identical or similar components of different examples. In addition, for better differentiation individual instances of a plurality of similar components are denoted by the addition of a suffix. If reference is to be made to all components of the same type, the use of the suffix is avoided.

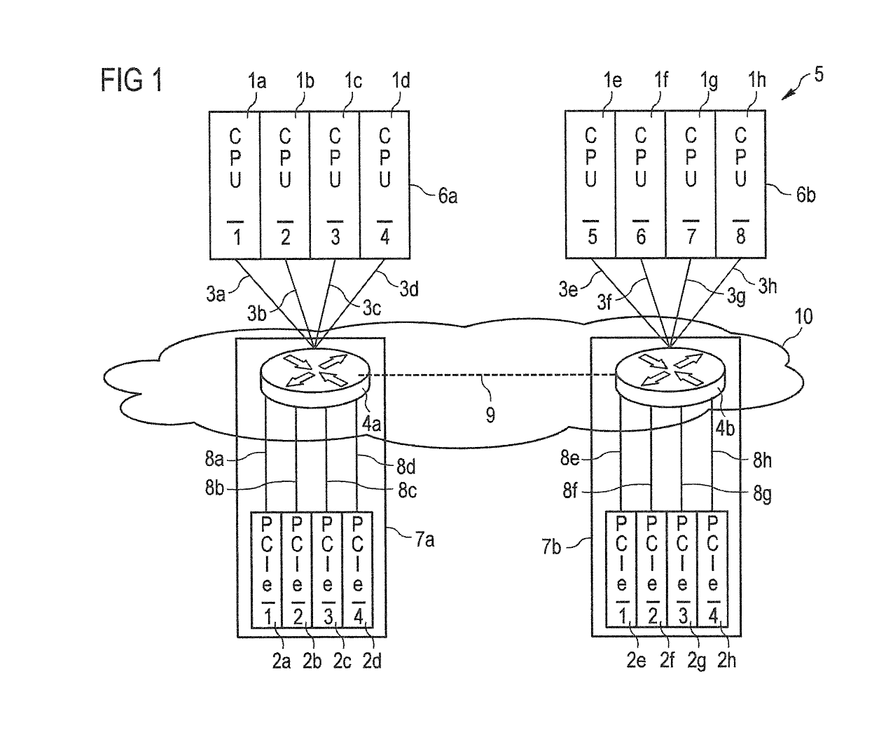

FIG. 1 shows a modular server system 5 according to a first example. The modular server system 5 comprises eight server modules 1a to 1h in two server groups 6a and 6b. Each of the server groups 6a and 6b comprises four server modules 1a to 1d and 1e to 1h respectively. Each server module 1 comprises at least one processor and typically working memories for executing one or more programs running on the server system 5.

The modular server system 5 further comprises eight I/O components 2a to 2h, which are likewise arranged in two I/O groups 7a and 7b. In addition, each I/O group 7a and 7b comprises an associated switch element 4a and 4b respectively. The I/O components 2 are, for example, network cards, mass storage means or other extension elements which the server modules 1 are able to access when executing programs. The example described concerns in particular I/O components for connecting to one or more server modules 1 via a PCI Express bus. Preferably, the I/O components support what is called “PCI Express device sharing”, that is, their simultaneous use by several root devices such as in particular server modules 1. The switch elements 4a and 4b are switch elements for connecting a plurality of PCI Express data lines, also known as PCI Express lanes.

Each of the server modules 1a to 1d of the first server group 6a connects via its own first connection 3a to 3d directly to the switch element 4a of the first I/O group 7a. Furthermore, each I/O component 2a to 2d of the first I/O group 7a connects via its own second connection 8a to 8d respectively directly to the first switch element 4a. In a corresponding manner the server modules 1e to 1h and the I/O components 2e to 2h connect via first connections 3e to 3h and second connections 8e to 8h, respectively, to the second switch element 4b of the second I/O group 7b. Finally, the first switch element 4a connects via a third connection 9 to the second switch element 4b. In the example, all connections 3, 8 and 9 correspond to the PCI Express x16 standard, that is, in each case have 16 differential data lines for parallel transmission and receipt of data. Together, the connections 3a to 3h, 8a to 8h and 9 and the switch elements 4a and 4b produce a connection fabric 10 of the modular server system 5, which allows a selective connection of each server module 1 to each of the I/O components 2. Here, the full bandwidth of a PCI Express x16 connection is available for each individual switched connection within a server group 6 and an associated I/O group 7.

The architecture shown in FIG. 1 is based on the realization that the access frequencies, access durations and access intensities between server modules 1 on the one hand and I/O components 2 on the other hand are unequally distributed. Preferably, the system is configured such that local I/O components 2, for example, mass storage components with local working data for a CPU of a server module 1, are accessed relatively often, whereas other I/O components 2 are accessed only relatively rarely.

In other application scenarios, for example, redundant cluster systems, the system is configured such that it accesses the primary I/O components 2 of a server module 1 relatively often, whereas it accesses a redundantly provided secondary I/O component 2 only in the case of failure of a primary I/O component 2.

In light of this knowledge, the architecture according to FIG. 1 has the advantage that with corresponding distribution of the I/O components 2 and server modules 1, the server modules la to 1d of the first server group 6a are able to access all components 2a to 2d of the first I/O groups 7a with high bandwidth and low latency via a dedicated data connection. Here, the access to other I/O components 2e to 2h of the second server group 7b via the connection 9 remains possible in exceptional cases, without further dedicated connections between the server modules 1a to 1d of the first server group 6a and the second switch element 4b being required. Instead, such data connections are established via a single or a few shared third connections 9, for example, in time multiplex.

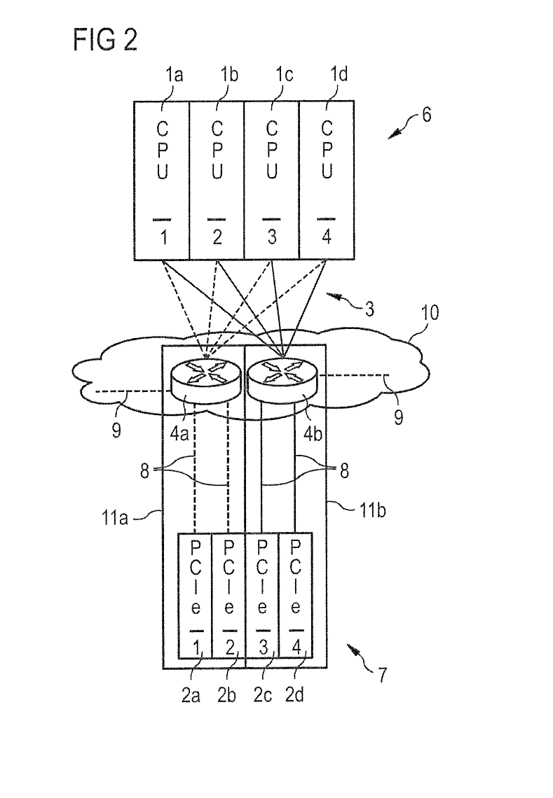

FIG. 2 shows a part of a modular server system 5 suitable in particular for implementing high availability systems. In the configuration according to FIG. 2, four identical server modules 1a to 1d of a single server group 6 access four shared I/O components 2a to 2d. To ensure an especially high availability of the I/O components 2a to 2d, these are divided into two subgroups 11a and 11b respectively. Here, the secondary I/O components 2c and 2d of the second subgroup 11b correspond functionally to the primary I/O components 2a and 2b of the first subgroup 11a. Together, the subgroups 11a and 11b form an I/O group 7 allocated to the server group 6.

To ensure the high availability, each of the server modules 1a to 1d connects via two separate first connections 3 to, respectively, a first switch element 4a of the first subgroup 11a and a second switch element 4b of the second subgroup 11b. The two switch elements 4a and 4b together form a switch arrangement of the I/O group 7. Within the first subgroup 11a and the second subgroup 11b the first switch element 4a, respectively, the second switch element 4b directly connect via a respective individual second connection 8 to the I/O components 2a and 2b, and 2c and 2d, respectively. Thus, even in the event of failure of any part, for example, a server module 1, an I/O component 2, a switch element 4 or one of the connections 3 or 8, data processing can continue.

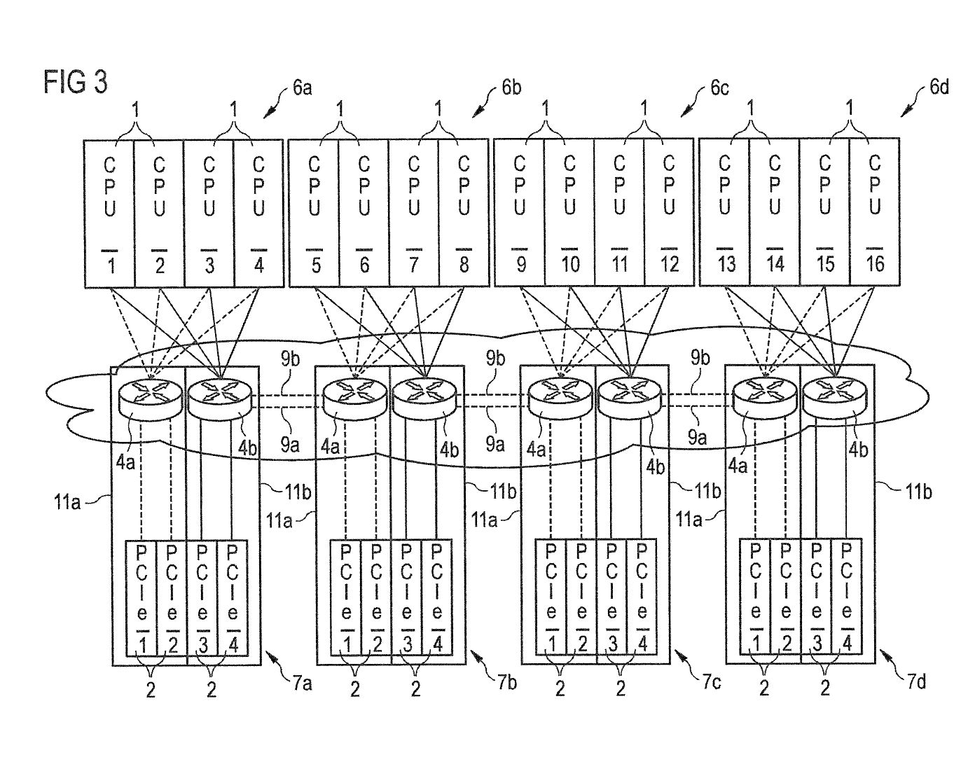

It is not necessary here to access adjacent I/O groups 7 via the third connections 9 (merely suggested in FIG. 2). If, for example, the first switch element 4a or the first I/O component 2a fails, the first server module 1a can continue a program it is executing using the second switch element 4b and the similar I/O component 2c. Only if at least two of the mutually redundant components of the I/O groups 7 fail, is access via the third connections 9 to components of adjacent I/O groups 7 needed, as will be described hereafter with reference to FIG. 3.

FIG. 3 shows the connection of a plurality of groups 7 and subgroups 11 according to FIG. 2 in a modular server system 5. In the example illustrated in FIG. 3, a total of 16 server modules 1, which are divided into four equal server groups 6a to 6d of four server modules 1 each, access a total of 16 I/O components, which are likewise divided into four I/O groups 7a to 7d, each with four I/O components 2. Here, each of the I/O groups 7a to 7d is subdivided into a first subgroup 11a and a second subgroup 11b, as described above with reference to FIG. 2.

To also create a redundancy in respect of the connections between different I/O groups 7, for example, two separate third connections 9a and 9b are provided between two adjacent I/O groups 7. Instead of the illustrated two connections 9a and 9b, other connection topologies may also be used. The connections 9a and 9b can be provided, for example, via a shared printed circuit board such as the backplane of the modular server system 5. In the example according to FIG. 3, the switch element 4a of each first subgroup 11a of each I/O group 7 is here coupled to the adjacent connection or connections 9a, and the switch element 4b of the second subgroup 11b of each I/O group 7 is coupled to the adjacent connection or connections 9b. As a result, a completely redundant modular server system 5 is produced, which offers an especially high degree of availability, performance and flexibility.

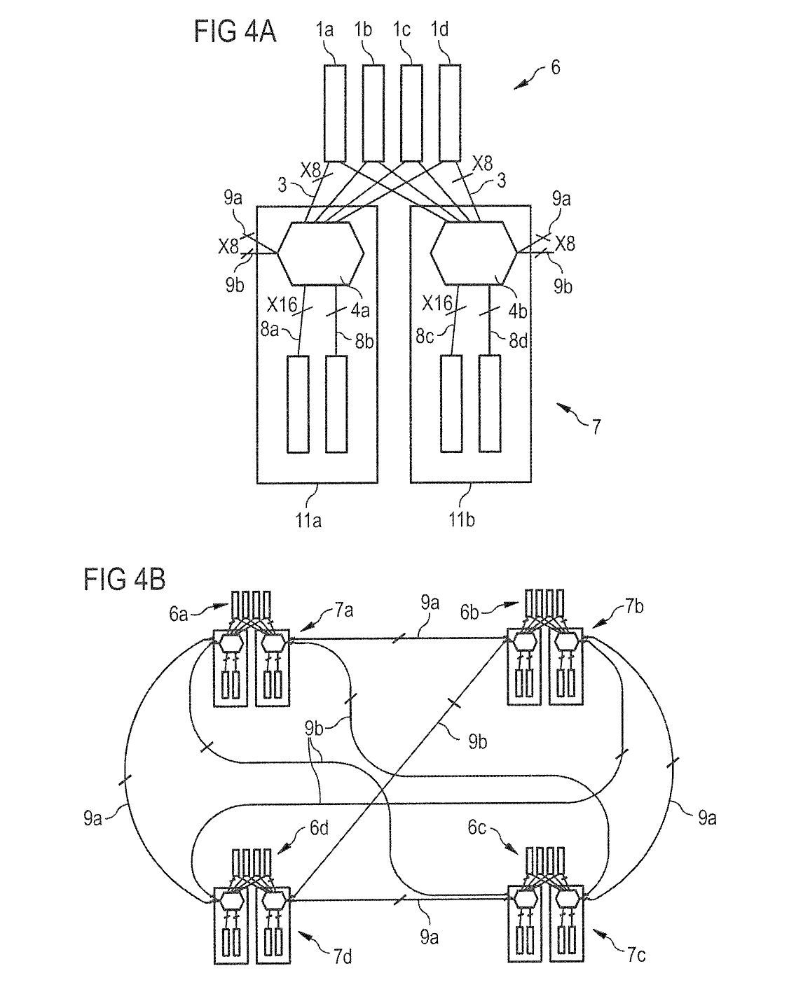

FIG. 4A shows another possible connection diagram for two switch elements 4a and 4b of a redundant I/O group 7 with two subgroups 11a and 11b. The first connections 3 between the switch elements 4a or 4b and one of a total of four server modules 1a to 1d of a server group 6 are each PCI Express x8 connections, each with eight differential line pairs for transmitting and receiving. The second connections 8a to 8d between the switch elements 4a and 4b and four I/O components 2a to 2d are constructed as PCI Express x16 connections, each with 16 differential line pairs for transmitting and receiving. In addition, at each switch element 4a and 4b two third connections 9a and 9b are provided in the form of PCI Express x8 connections, each with eight differential line pairs to transmit and receive. Thus, for example, known PCI Express switch components with 81 freely configurable PCI Express lanes are suitable. Here, the terminals for the connections 3 and 8 are each configured as endpoints, while the terminals for the connections 9 are configured as routing connections. The remaining 81^{st} terminal is used in one configuration for control purposes and is, for example, coupled to other switch elements, to a system management component or some other control component of the server system.

The different design of the connections enables the performances thereof to be matched to the requirements of the modular server system 5. For example, an especially efficient I/O component 2a such as a mass storage system for instance, which is used simultaneously by two server modules 1a and 1b, can be connected to the switch element 4a via a second connection 8a having a higher connection speed than the two first connections 3 of the server modules 1a and 1b. It is an advantage here that the second connections extend with a high number of conductor tracks only within the I/O group 7, whereas the first connections 3 and the third connections 9 require a lower number of conductor tracks.

Since each of the server modules 1a to 1d of the server group 6 is already directly coupled to both switch elements 4a and 4b, a direct cross-connection between the first switch element 4a and second switch element 4b can be omitted. Instead, the switch elements 4a and 4b connect to switch elements 4 of other I/O groups 7 to produce a connection fabric 10, which is suitable, for example, to implement a modular server system 5 with 16 server modules 1 and 16 I/O components 2, as per FIG. 4B.

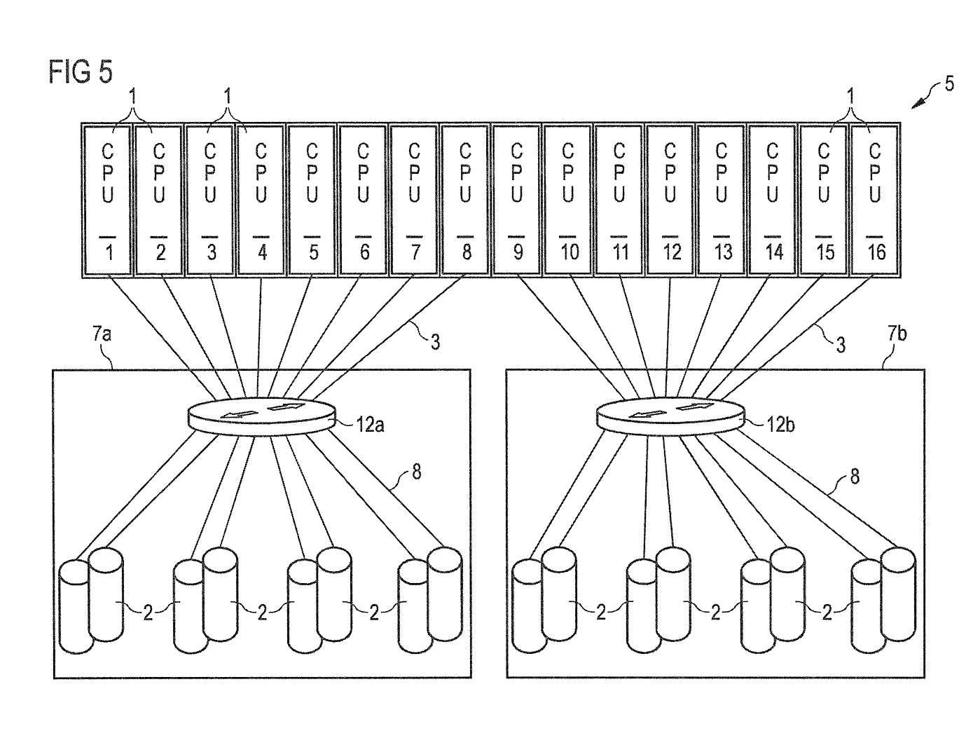

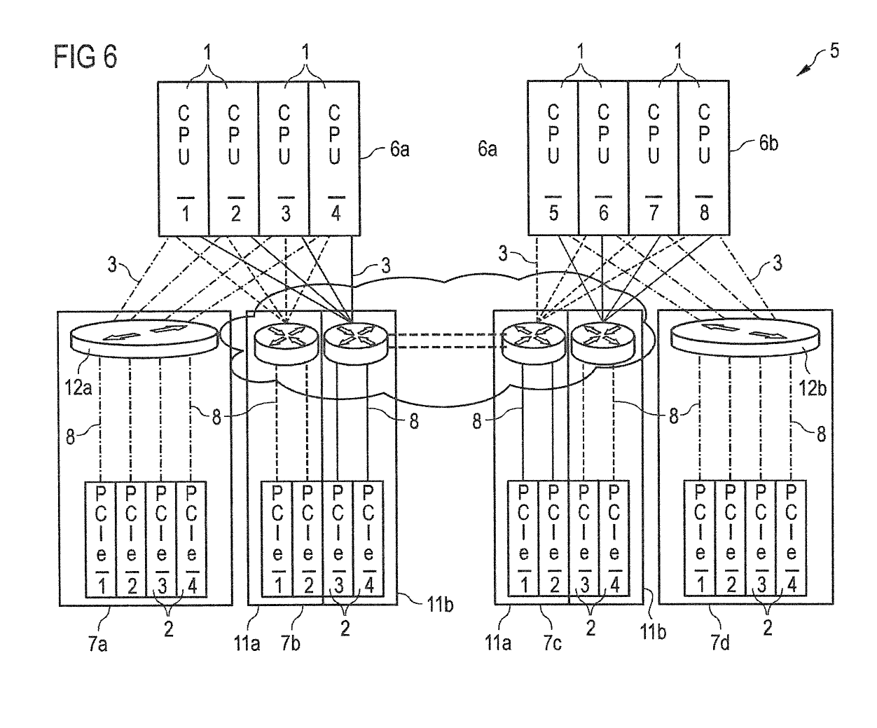

In addition to the possibility of setting up a distributed modular connection fabric 10, the described modular server architecture also offers the possibility of implementing different connection topologies in a standardised modular server system. This is illustrated for example, in FIGS. 5 and 6.

In the topology illustrated in FIG. 5, instead of switch elements, use is made of retimer devices 12a and 12b in two I/O groups 7a and 7b, each with eight I/O components 2. As a result, each of 16 server modules 1 can therefore access only a single I/O component 2, in the example according to FIG. 6, for example, a solid-state disk (SSD). Access to adjacent I/O components on the other hand, either of the same I/O group 7 or of the adjacent I/O group 7, is not possible.

It should be noted that the first connections 3 and the second connections 8 correspond exactly to the connections needed to create a distributed modular switch architecture. This fact allows different configurations to be set up in an especially simple and inexpensive manner using the same basic components. In particular, it is not necessary to provide different server modules 1, I/O components 2, backplanes or midplanes to implement different system architectures. Only the active components and internal connection matrix of the I/O groups 7 that is used need to be adapted accordingly.

According to the requirements of a client, the connection topology of the modular server system 5 can therefore be altered simply by replacing an I/O module used containing the functional elements of an I/O group 7. For example, for a client who wishes to dispense with a high availability of the I/O components 2, relatively inexpensive retimer devices 12 can be used instead of switch elements 4.

Naturally, a mixed operation of both topologies is also possible, as illustrated for example, in FIG. 6. The modular server system 5 illustrated therein comprises two server groups 6a and 6b and four I/O groups 7a to 7d. The I/O components 2 of the first and fourth I/O groups 7a and 7d respectively are directly connected via retimer devices 12a and 12b respectively to a respective one of the server modules 1.

For example, these are co-processor cards allocated to a processor of one of the server modules 1 in each case as a non-divisible resource. The remaining I/O components 2, for example, network cards with several logical or physical network interfaces, are, as described with reference to FIGS. 2 and 3, redundantly connected via switch elements 4a to 4d to all server modules 1 of the modular server system 5. In this case, as described above, they are divided into in each case two redundant subgroups 11a and 11b per I/O group 7.

In this configuration too, it is not necessary to alter the connections provided, for example, on a backplane. In the example the connections 3 between server modules 1 and retimer devices 12 are established via PCI Express x16 connections. The connections between a server module 1 and each one of the two switch elements 4 directly connected thereto are established via PCI Express x8 connections. As a result, for each of the I/O groups and independently of the internal topology thereof, 16 PCI Express lanes per server module 1 and 64 PCI Express lanes per I/O group 7 are needed.

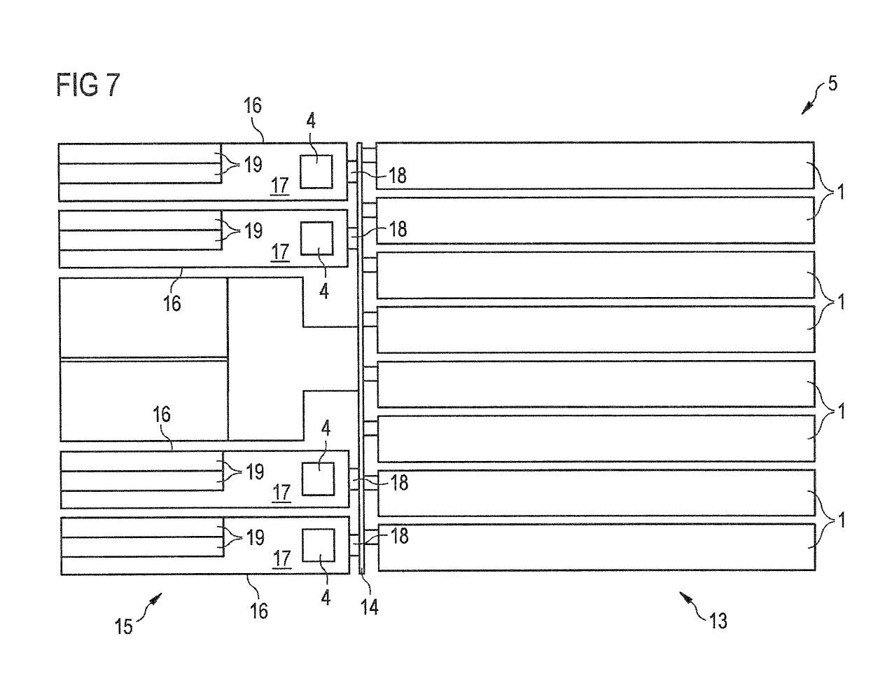

FIG. 7 shows a top view onto a housing of a modular server system 5. For example, this is what is called a blade server system adapted to receive a plurality of server modules 1.

The server modules 1 accommodated in a front housing segment 13 are coupled via suitable plug connectors to a midplane 14. The midplane 14 is a shared printed circuit board with a multiplicity of electrical connections, which in the example comprises no active components.

On the rear side of the midplane 14, plug connectors for the attachment of further components of the blade server system are arranged in a rear housing segment 15. In addition to general infrastructure components such as in particular power supplies and system fans, four I/O modules 16 suitable for receiving I/O components 2 are also arranged in the modular server system 5 according to FIG. 7. For example, each I/O module 16 is suitable to receive two PCI Express expansion cards 19 each. The I/O modules 16 each comprise a module printed circuit board 17 with a switch element 4 arranged thereon and a plug connector 18 to electrically couple the I/O module 16 to the midplane 14.

Additionally, further I/O modules, optionally with a different form factor, can be arranged at other locations in the housing. For example, it is possible to arrange further I/O modules to receive mass storage means, which do not have the installation height of a PCI Express expansion card, between or beneath the power supplies of the modular server system 5.

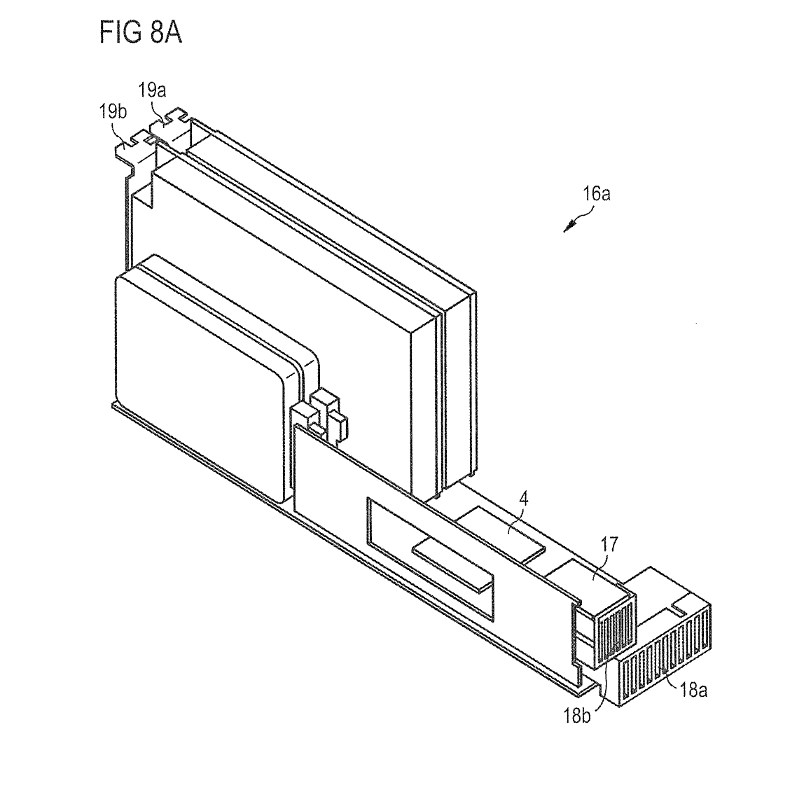

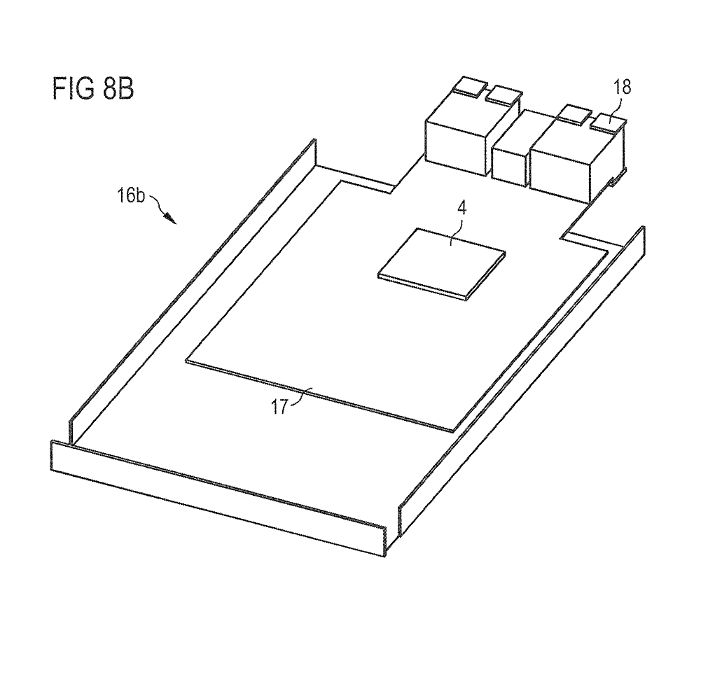

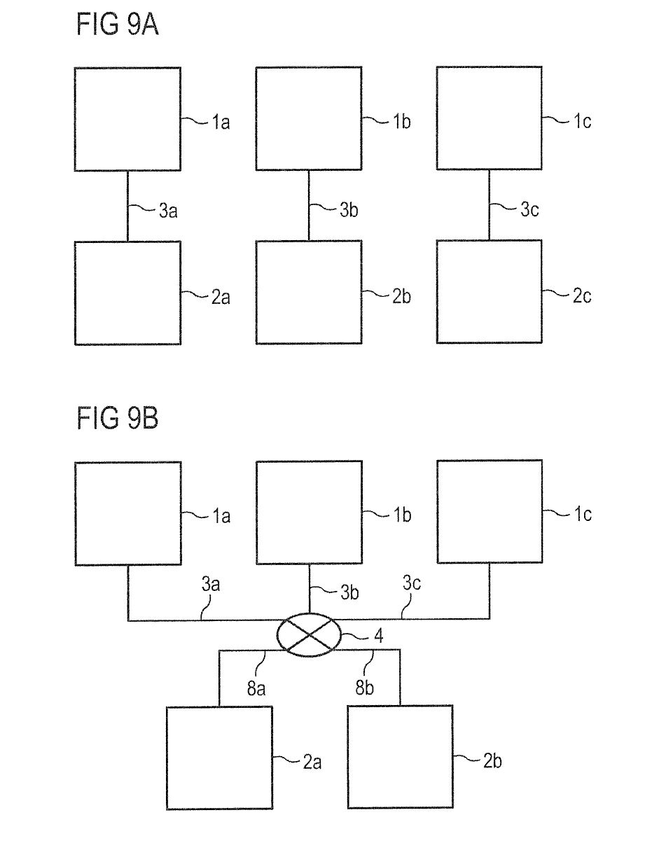

FIGS. 8A and 8B illustrate examples of different I/O modules 16a and 16b.

The I/O module 16a according to FIG. 8A is used, for example, to receive two PCI Express expansion cards 19a and 19b. A switch element 4, which is able to connect expansion cards 19a and 19b received in two PCI Express x16 slots selectively via the plug connector 18a to different server modules 1, is arranged on the printed circuit board 17. Using a further plug connector 18b, via the midplane 14 third connections 9 to other I/O modules 16 can also be established.

The I/O module 16b according to FIG. 8B receives a multiplicity of non-volatile memory devices that jointly form a mass storage system. The non-volatile memory devices are arranged directly on the module printed circuit board 17 of the I/O module 16b. In addition, a switch element 4 is also arranged on the printed circuit board 17 so that different data connections from different server modules 1 to the non-volatile memory devices can be established. The I/O module 16b comprises a plug connector 18 to establish second connections 8 to server modules 1 and third connections 9 to other I/O modules 16. Further plug connectors or terminals are not needed and, therefore, the I/O module 16b is also suitable for installation at inaccessible locations of the modular server system 5.

The architecture described allows modular server systems 5 to be set up in which a multiplicity of different connection topologies between individual server modules 1 and I/O components 2 can be achieved. In this case, by suitable choice of the bus widths of connections 3, 8 and 9, and components used of the connection fabric 10, different data transmission speeds and modes between individual server modules 1 and I/O components 2 coupled therewith can be achieved.

The architecture was described with reference to different server systems, in which one or two switch elements 4 of a switch arrangement are each allocated to the I/O groups 7 and are also arranged there. Provided that the logical allocation of I/O groups 7 to exactly one server group 6 is maintained, parts of or the entire switch arrangement itself can, of course, be arranged at a different location of the modular server system, for example, on a backplane or midplane 14 or in a different component such as a module to receive a server group.

Moreover, it is also possible to reverse the entire architecture, that is, to allocate the server groups to exactly one I/O group. In that case, the corresponding switch elements and arrangements are allocated logically to the server groups and preferably also arranged in spatial proximity to the server modules. In that case, there is the additional advantage that a direct high-speed communication between the server modules of a server group via the switch arrangement logically allocated to the server group is facilitated. Here too, an arrangement on a backplane or midplane or a different component such as the I/O modules, is possible as an alternative.

The mode of operation corresponds to that of the above-mentioned examples, wherein generally the functions and connections of the particular server groups and I/O groups are in each case interchanged. The examples according to FIGS. 1 to 6 are based furthermore on a 1:1 allocation between server groups 6 on the one hand and I/O groups 7 on the other hand so that apart from the logical allocation of the switch arrangements to the server groups 6, no further changes arise.

The architectures described allow a redundancy to be created with respect to the server modules 1, switch elements 4 and I/O components 2 and connections 3, 8 and 9 used, as well as the simple changeover to redundantly provided replacement components. At the same time, the necessary connection fabric 10 is considerably reduced compared with a full linkage of each server module 1 to each I/O component 2.

The described architectures therefore offer inter alia the following advantages:

Controlled shared access to I/O components 2 of a local I/O group 7 by server modules 1 of a server group 6.

Reduced complexity of a midplane 14.

The option also to use I/O components 2 of remote I/O groups 7.

Creation of a redundancy in respect of the connections 3, 8 and 9 between server modules 1 and I/O components 2.

Linear scaling of the complexity and cost of the connection fabric 10 according to the assembly of the modular server system 5.

The option to combine different connection topologies in a single modular server system 5.

The option to create hotplug capabilities for the I/O components 2 and/or I/O modules 16 used.

The option to create a transparency in respect of the operating systems and programs running on the server modules by shifting the switching and redundancy functionality to the PCI Express connection fabric 10.

The details shown in the examples and described above can be combined with one another in many ways to achieve the advantages and effects described.

1.-12. (canceled)

13. A modular server system comprising:
a plurality of server groups, wherein each server group is adapted to receive a plurality of server modules, and
a plurality of I/O groups, wherein each I/O group is adapted to receive a plurality of I/O components and comprises a switching arrangement with at least one switch element,
wherein
each of the plurality of I/O groups is allocated to exactly one of the plurality of server groups,
the switch arrangement of each I/O group is directly coupled by a data link to each of the plurality of I/O components of the I/O group,
the switch arrangement of each I/O group is directly coupled by a data link to each of the plurality of server modules of the server group allocated to the I/O group, and
the switch arrangement of each I/O group is coupled by a data link to at least one other switch arrangement of another I/O group.

14. The modular server system according to claim 13, wherein at least one first I/O group of the plurality of I/O groups comprises at least one first subgroup with a first switch element and a second subgroup with a second switch element, the first switch element is directly coupled by a data link to each server module of a first server group allocated to the first I/O group and the second switch element is directly coupled by a data link to each server module of the first server group.

15. The modular server system according to claim 13, further comprising at least one shared printed circuit board with a plurality of first electrical connections that couple the server groups to the respective allocated I/O groups by a data link.

16. The modular server system according to claim 15, wherein the at least one shared printed circuit board comprises a plurality of further electrical connections that couple together the switch arrangements of the plurality of I/O groups by a data link.

17. The modular server system according to claim 13, wherein the coupling by a data link via point-to-point connections is established with a plurality of data lines according to the PCI Express standard.

18. The modular server system according to claim 13, wherein the at least one first I/O component of the plurality of I/O components can be shared by a plurality of server modules, and the first I/O component is one of a power supply component with a plurality of functional units and a mass storage component.

19. The modular server system according to claim 13, wherein the plurality of I/O components of at least one first I/O group of the plurality of I/O groups and/or the plurality of server modules of at least one allocated first server group of the plurality of server groups form a redundant system so that on failure of one of the I/O components of the first I/O group and/or on failure of one of the server modules of the first server group, remaining I/O components of the first I/O group and remaining server modules of the first server group are able to assume the function of the failed components.

20. The modular server system according to claim 13, wherein first data connections between server modules of a first server group and I/O components of a first I/O group allocated to the first server group have a higher data rate and/or a lower latency than second data connections between server modules of the first server group and I/O components of a second I/O group not allocated to the first server group.

21. The modular server system according to claim 13, wherein each server module comprises at least one processor and at least one main memory associated with the processor.

22. A modular server system comprising:
a plurality of server groups, each server group adapted to receive a plurality of server modules and comprising a switch arrangement with at least one switch element, and
a plurality of I/O groups, wherein each I/O group is adapted to receive a plurality of I/O components,
wherein
each of the plurality of server groups is allocated exactly one of the plurality of I/O groups,
the switch arrangement of each server group is directly coupled by a data link to each of the plurality of server modules of the server group,
the switch arrangement of each server group is directly coupled by a data link to each of the plurality of I/O components of the I/O group allocated to the server group, and
the switch arrangement of each server group is directly coupled by a data link to at least one other switch arrangement of another server group.

23. The modular server system according to claim 22, further comprising at least one shared printed circuit board with a plurality of first electrical connections that couple the server groups to the respective allocated I/O groups by a data link.

24. The modular server system according to claim 23, wherein the at least one shared printed circuit board comprises a plurality of further electrical connections that couple together the switch arrangements of the plurality of server groups by a data link.

25. The modular server system according to claim 22, wherein the coupling by a data link via point-to-point connections is established with a plurality of data lines according to the PCI Express standard.

26. The modular server system according to claim 22, wherein the at least one first I/O component of the plurality of I/O components can be shared by a plurality of server modules, and the first I/O component is one of a power supply component with a plurality of functional units and a mass storage component.

27. The modular server system according to claim 22, wherein the plurality of I/O components of at least one first I/O group of the plurality of I/O groups and/or the plurality of server modules of at least one allocated first server group of the plurality of server groups form a redundant system so that on failure of one of the I/O components of the first I/O group and/or on failure of one of the server modules of the first server group, the remaining I/O components of the first I/O group and the remaining server modules of the first server group are able to assume the function of the failed components.

28. The modular server system according to claim 22, wherein first data connections between server modules of a first server group and I/O components of a first I/O group allocated to the first server group have a higher data rate and/or a lower latency than second data connections between server modules of the first server group and I/O components of a second I/O group not allocated to the first server group.

29. An I/O module for use in a modular server system comprising:
at least one module printed circuit board,
at least one first terminal arranged on the module printed circuit board for a first I/O component,
at least one second terminal arranged on the module printed circuit board for a second I/O component,
at least one plug arranged on the module printed circuit board that couples the I/O module to a shared printed circuit board of the modular server system by a data link, and
at least one switch element arranged on the module printed circuit board that selectively establishes data connections between a predetermined group of server modules of the modular server system, said predetermined group being allocated to the I/O module, and the first and/or second I/O component, and establishes data connections between the predetermined group of server modules of the modular server system and a switch element of a similar I/O module.

30. A switching method for a modular server system comprising:
directly establishing first data connections between a first component of a first type of a first group of similar components, and a second component of a second type of a second group of similar components via a first switch element of the second group; and
indirectly establishing second data connections between the first component of the first group and a third component of the second type via the first switch element and a second switch element of the third group.

31. The method according to claim 30, wherein the first data connections have a higher data rate and/or a lower latency than the second data connections.

32. The method according to claim 30, wherein the first data connections can be used exclusively by the first component of the first group and the second component of the second group and wherein the second data connections can be shared by a plurality of components of the first group and/or a plurality of third components of the third group via a multiplex operation.
